(19) United States
(12) Patent Application Publication
(10) Pub. No.: US 2007/0091325 A1
(43) Pub. Date: Apr. 26, 2007

(54) Multi-channel optical metrology

(75) Inventor: Mehrdad Nikoonahad, Menlo Park, CA (US)

Correspondence Address: HARRINGTON & SMITH, PC, 4 RESEARCH DRIVE, SHELTON, CT, 06484-6212, US

(73) Assignee: Mehrdad Nikoonahad, Menlo Park, CA (US)

(21) Appl. No.: 11/316,476

(22) Filed: Dec. 21, 2005

Related U.S. Application Data
(60) Provisional application No. 60/641,979, filed on Jan. 7, 2005.

(51) Int. Cl. G01B 11/14

(52) U.S. Cl. 356/625

(57) ABSTRACT

A metrology system of the instant invention is configured to characterize features or structures formed on a surface of an article of manufacture. A metrology or measurement system comprises at least two channels wherein each channel comprises one or more radiation sources, illumination optics, collection optics comprising at least one window and one detector array, and processing means for comparing a received signal pattern to a calculated or previously processed signal pattern of a predetermined array of two dimension or three dimension structures or features on a surface of an article of manufacture such as a wafer, in a preferred embodiment.

### CROSS REFERENCE TO RELATED APPLICATIONS

This application claims the benefit of U.S. provisional application Ser. No. 60/641,979 filed on Jan. 7, 2005 which is fully incorporated herein by reference.

### FIELD OF INVENTION

This invention relates generally to optical metrology and more particularly to measurement of three dimensional critical dimensions using principles of scatterometry.

### BACKGROUND OF INVENTION

Semiconductor processing is a well established technology for making integrated circuit (IC) devices such as those used in computers, memory cells and digital cameras. Transistors, which are the active part of an IC, are formed in the semiconductor and film stacks consisting generally of alternating dielectrics and metals are built on top of the semiconductor. These films vary in thickness from a few Angstroms to a few microns depending on what function they serve. The device is built layer by layer starting from a surface of a semiconductor. Dielectric films are etched at specific lithographically defined locations to form vias or contacts. Vias or contacts are filled with conducting materials such as metals so that connections can be made from upper layer interconnects to lower layer interconnects. Interconnects connect different points of the device to each other within one plane. By far the smallest dimension that is printed and manufactured is at the transistor level; features used to control various aspects of a manufacturing process are frequently referred to as “critical dimensions” or CD's.

Clearly, if a CD changes for whatever reason there is a drastic change in the performance of an IC and a device may in fact simply fail. CD monitoring and tight control of CD is therefore, crucial in wafer processing. The instant invention is concerned with optical technologies for three dimensional critical dimension and overlay measurement employing a single system, in this case, the instant invention. CD measurement involves making dimensional measurement of structures such as a width of a line or trench, or a sidewall angle of a via. Overlay measurement involves measurement of an alignment between structures on two separate planes during wafer processing. As IC processing progresses toward smaller dimensions both CD and overlay metrology become increasingly difficult.

Scatterometry is described in U.S. Pat. Nos. 6,429,943, 6,433,878, 6,483,580, 6,451,621, 6,721,052, 6,900,892. Scatterometry relies on making dimensional measurement on a repetitive array of structures of interest. Often the structures of interest are significantly smaller than the wavelength of light employed and non-resolvable. For example an optical microscope is not capable of resolving details smaller than about 400 nm. However, in scatterometry a multitude of features comprising two dimensional patterns and three dimensional structures are illuminated simultaneously, the reflected, or scattered, spectrum is affected by the array characteristics of the multiplicity of features and structures. In scatterometry, one measures a spectral signature as a function of an illumination angle or wavelength. Such spectral signatures are a characteristic of features within the structure that one wants to measure.

Traditionally, the hardware part of a scatterometry system has been either a reflectometer or an ellipsometer or hardware which can be related to either a reflectometer or ellipsometer. Historically, the primary application of ellipsometry and reflectometry was for film thickness measurements; thin film applications are generally one dimensional measurements without any structural features being present on the film. More recently scatterometry has been used for measuring two dimensional arrays or parallel lines. Many structures of present interest during semiconductor processing are three dimensional (3D) in nature. For example an array of vias or contacts comprises three dimensional features. Recent transistor designs called FinFET or Trigate have three dimensional features of interest. Even with reference to traditional transistor designs Line Edge Roughness, LER, or Line width Roughness, LWR, are two critical parameters of interest; both 3D in nature and, furthermore, during the manufacturing of an IC generally a number of transistors are printed simultaneously and, thus there are 3D structures of interest. Scatterometry systems rely on illuminating a wafer from one azimuthal direction. This limitation fails to provide adequate information for 3D metrology of structures of interest.

U.S. Pat. No. 6,867,862, fully incorporated herein by reference and assigned to the present inventor, teaches variable azimuthal angle illumination by requiring a rotating platform. Alternative and less expensive embodiments are needed particularly in the area of integrated metrology where a metrology module is attached to a process toll such a track used in the litho section of the fab. In view of the foregoing, a need exists for an improved metrology and process monitoring system that overcomes the aforementioned obstacles and deficiencies of currently-available systems.

### SUMMARY OF INVENTION

The various embodiments disclosed herein are directed toward a metrology or process monitoring system, referred to separately and collectively as a “metrology system” that is configured to make one or more dimensional measurements on two dimensional or three dimensional structures in a predetermined array of selected structures, patterns or features. Each embodiment is a metrology system comprising a measurement system that is in communication with a processing system. A metrology system of the instant invention is configured to characterize features or structures formed on a surface of an article of manufacture. A metrology or measurement system comprises at least two channels wherein each channel comprises one or more radiation sources, illumination optics, collection optics comprising at least one window and one detector array, and processing means for comparing a received signal pattern to a calculated or previously processed signal pattern of a predetermined array of two dimension or three dimension structures or features on a surface of an article of manufacture such as a wafer, in a preferred embodiment. In all embodiments a beam of radiation is generated by a source, processed and directed toward an object being measured by illumination optics; simultaneously energy reflected or scattered from the object is being received by collection optics and transmitted to processing means for analysis and comparison. Processing means may comprise single or multiple processors operating sequentially or in parallel and in communication with a metrology system; a processing means may be a physical part of a metrology system or located remotely. A processing means may be associated with two or more channels operating in a multiplexing mode.

Other aspects and features of various embodiments disclosed herein will become apparent from consideration of the following description taken in conjunction with the accompanying drawings.

### BRIEF DESCRIPTION OF DRAWINGS

FIG. 1 shows schematically structures of interest encountered in silicon processing.

FIG. 2 shows schematic top view of some example 3D structures adjacent to each other to form arrays. Arrays are not to scale and are shown here only by the way of example; the figures are not a comprehensive list, serving only as examples.

FIG. 3 is a top view of a single measurement channel. Illumination optics illuminates a repetitive array of structures of interest on a surface of a wafer and collection optics collects and converts the scattered or reflected radiation to electronic signals. Collection optics communicates with means for data acquisition and processing (not shown).

FIG. 4 shows relevant angles with reference to an illumination beam.

FIG. 5 shows a single channel of a broadband system.

FIG. 6 shows a multiple-line system.

FIG. 7 shows a three channel system with channels located φ=0, φ=45°, and φ=90°.

### Detailed Description of Embodiments

Definitions

A radiation source is a device that can generate optical energy from infrared to soft x-rays, wavelengths from about 10 micrometers to 10 about nanometers. Broadband or polychromatic sources are ones that generate a broad range of wavelengths simultaneously. These lamps include xenon or mercury arc lamps as well as deuterium lamps. Monochromatic sources are generally lasers. A monochromatic source may be implemented by a broadband source in conjunction with a narrow band filter after the source. For example, for a wavelength of 193 nm, lasers with a Gaussian output, running continuously, are not available at a reasonable cost; a deuterium lamp in conjunction with a narrow band filter can serve as a low cost substitute. This wavelength is of particular interest in this invention because this is a primary lithographic wavelength; there is a great deal of interest by semiconductor manufacturers to carry out the measurements around this wavelength. 193 nm is the shortest wavelength that propagates in air with tolerable adsorption and there is no requirement for vacuum; shorter wavelengths result in better measurement as critical dimensions become smaller. In some embodiments each channel has a dedicated source; in other embodiments an apparatus comprising multiple channels may have one source supplying all the channels; alternatively, two or more sources may be shared among two or more channels.

Illumination optics comprise an ensemble of optical components which include, optionally, reflective optics, fiber optics, lenses, optical filters, diffraction gratings, polarizers, wave plates, windows, opto-mechanical holders, beam-splitters, dichroic mirrors, optical modulators, telescopes, collimators, spatial light modulators, means for rotating a polarizer continuously or not, and spatial filters. Illumination optics condition or modulate a beam of one or more radiation energies impinging on a surface under examination; for the purposes of this invention a surface under examination is a predetermined region comprising at least a two or three dimensional grating structure on an article of manufacture, in a preferred embodiment a semiconductor wafer.

Collection optics is an ensemble of optical components comprising, optionally, reflective optics, fiber optics, lenses, optical filters, diffraction gratings, analyzers, wave plates, windows, opto-mechanical holders, telescopes, collimators, spatial filters, beam-splitters, dichroic mirrors, photodetectors, silicon detectors, photomultiplier tubes, CCD's, linear arrays, means for rotating an analyzer continuously or not, and spatial filters. Collection optics conditions a beam of one or more radiation energies received from a surface under examination, detects photons in a conditioned beam, converts photons to one or more signals, measures intensity of one or more signals, transmits one or more measurements to a processing means such that one or more parameters of examined surface may be calculated from collected radiation.

Beam delivery system is an ensemble of optical components comprising, optionally, dichroic mirrors, filters, beam splitters, optical fiber, fiber couplers, fiber splitters, diffraction-gratings for delivering radiation energy from one or more radiation sources, monochromatic or not, to illumination optics for a channel.

A multiple-line beam delivery system comprises two or more discrete wavelengths with a relatively small spectral width. A multiple line system may have two or more discrete wavelengths such as 633 nm, 532 nm and 193 nm or 670, 488, 193 nm. The aforementioned wavelengths are examples for wavelengths used in multiple-line systems; depending on the measurement desired, any combination of wavelengths may be used; a multi-line system may comprise two or more laser sources.

Polarizer and analyzer are optical components that let through a given state of polarization of incoming radiation. A polarizer is generally placed in the illumination optics; an analyzer is normally found in the collection optics. Alternatively, a polarizer or an analyzer may include rotating means which can be used to rotate a component as needed.

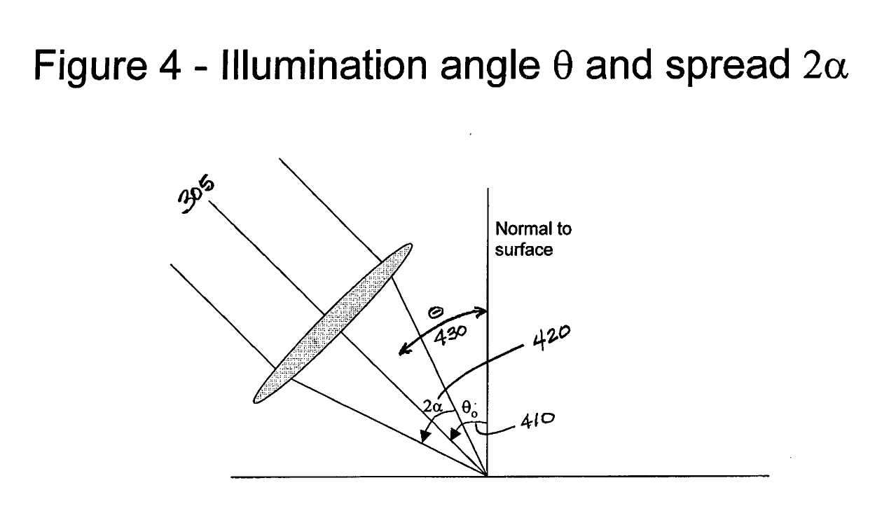

An illumination angle has two components to it, a fixed and a spread component. A fixed component of an illumination angle is an angle between a principal ray of an illumination beam and a normal to a surface. A spread component of an illumination angle is the angular spread around the fixed angle. Angle θₒ is an illumination angle and angle α is one half the spread component in FIG. 4. For a focused beam a fixed illumination angle, θₒ, is the angle a beam makes with a surface and the spread components are those angles allowed by a numerical aperture (NA) of a lens. A reflected radiation wave will have the same structure; measurements made as a function of illumination angle comprise a range of angles, 2α about θₒ. In this case a variable, θ, varies from θₒ−α to θₒ+α. By changing the NA a varying range of angles can be achieved, such as from ±1° to ±450.

Wavelength separation optics comprises an ensemble of optical components comprising reflective optics, dichroic mirrors, filters, beam splitters, optical fiber, fiber couplers, diffraction gratings, prisms or combinations of these devices for separating wavelengths of collected radiation in a collection optics. A grating or prism based spectrometer is a specific type of wavelength separation optics for spreading a broadband beam into its constituent spectrum, for example, a rainbow in the case of sun light. For a case when the received or collected radiation comprises one or more discrete wavelengths, a wavelength separation optics may comprise one or more dichroic mirrors and beam splitters or alternatively several beam splitters in conjunction with the same number of narrowband filters.

The term “parameter” is applied to a signal intensity, phase, phase difference, and one or more combinations of phase and amplitude for one or more settings of a polarizer and analyzer. A parameter may be measured by rotating a polarizer or an analyzer, or both. Ellipsometric parameters, ellipsometric ψ or Δ, may be functions of wavelength, λ, or illumination angle, θ; polarization type S or P are parameters as well. A processor analyzes and compares spectral data as a function of at least one parameter chosen from a group comprising azimuthal angle, φ, illumination angle, θ, wavelengths, λ, polarization state S or P, angular spread, α, ellipsometric parameters, ellipsometric ψ or Δ, signal intensity, phase, phase difference, and one or more combinations of phase and amplitude for one or more settings of a polarizer and analyzer.

A measurement channel comprises a discrete apparatus comprising, optionally, radiation source, illumination optics, detection or collection optics and processing means comprising algorithms for data manipulation, extraction, and measurement and appropriate hardware. Note that a channel has a given azimuthal angular position, φ, relative to the array of structures being measured; illumination optics are located at φ and collection optics at φ+180°. The following configurations are some examples of a channel:

a) Illumination optics illuminates a wafer at illumination angles in the range of 1 to 89 degrees, a fixed or rotating polarizer and a fixed or rotating analyzer in the collection optics; variables in the measurement are wavelength λ or illumination angle, θₒ, or both. Note, the illumination angle being collected is θ, defined as θₒ±α; the angular position of illumination and collection optics is θₒ; the detector positioned in a collection optics detects radiation at θ based on the angular spread and the pixel size and location in the detector; a given pixel in a detector detects a unique θ, as θₒ−α₁ based on its location; another pixel will have a slightly different θ, as θₒ−α₂. Different pixels detect slightly different, and unique, information about an array being illuminated.

b) Illumination optics illuminates a wafer at an illumination angle, θₒ, in the range of 1 to 89 degrees; a polarizer is stationary; in the collection optics by means of a beam splitter or beam divider, a beam is divided into two parts each of which are analyzed with a separate analyzer; both S and P polarizations are detected; variables in the measurement are wavelength λ or illumination angle θ or both, simultaneously.

c) Illumination optics illuminates a wafer at an illumination angle, θₒ, in the range of 1 to 89 degrees; a polarizer is absent; a fixed or rotating analyzer is in a set of collection optics; variables in a measurement are wavelength λ or illumination angle θ or both, simultaneously.

d) Illumination optics illuminates a wafer at an illumination angle in the range of 1 to 89 degrees; a fixed or rotating polarizer is present; an analyzer is absent in a set of collection optics; variables in a measurement are wavelength λ or illumination angle θ or both, simultaneously.

e) Illumination optics illuminates a wafer at an illumination angle in the range of 1 to 89 degrees; neither a polarizer or analyzer is present; variables in a measurement are wavelength λ or illumination angle, θₒ, or both, simultaneously.

f) Illumination optics illuminates a wafer at an illumination angle in the range of 1 to 89 degrees; optionally, a fixed or rotating polarizer and a fixed or rotating analyzer are used, resulting in four possible configurations for a channel.

A source for each channel configuration stated above may be a broadband source, a laser source or a multi-line source. For a case of a single laser source the measurement may be done only as a function of an illumination angle, θₒ.

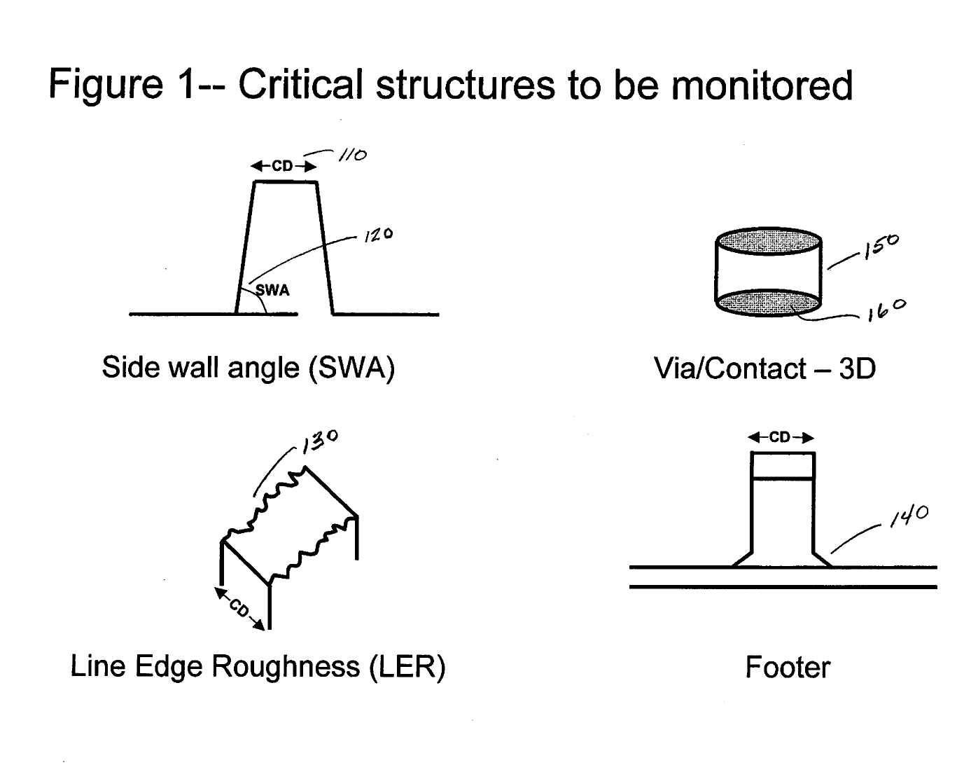

FIG. 1 shows schematically example structures of interest encountered in silicon processing. A CD 110 and side wall angle, SWA, 120 on resist lines and a line edge roughness 130 as shown are important variables to measure. Also a footer 140, which results from specific chemistry employed and changes during etch, is critical in the operation of the transistor. Via 150 and contact 160 are typically rounded structures; a side wall angle in vias or wells is important to characterize and it is crucial to determine whether or not the bottom of a via is open. Each of the foregoing is an important structure or feature to measure and characterize for process control.

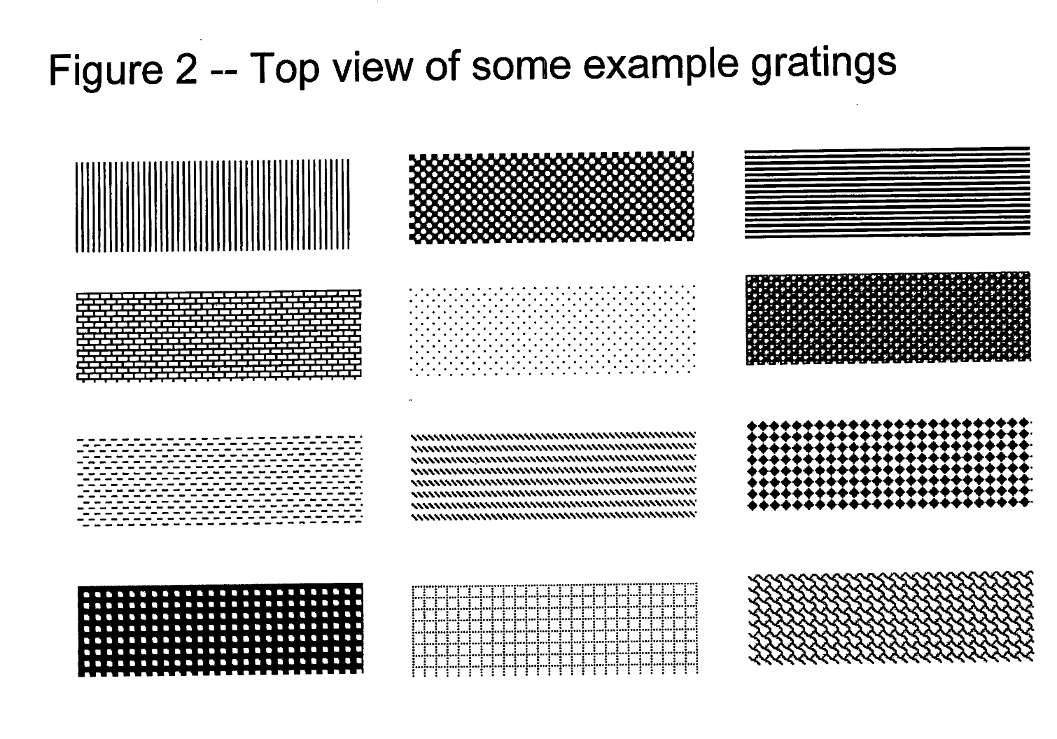

FIG. 2 shows a schematic top view of example two and three dimensional structures adjacent to each other to form arrays. The arrays are not to scale and are shown here only by way of example, not meant to provide a comprehensive list. Note other structures and arrays are possible and known to those skilled in the art. Two or more different structures may be combined in a given array as long as the geometrical position of each remains fixed relative to the other as the combination is repeated within the array, similar to a crystalline unit cell of several different atoms.

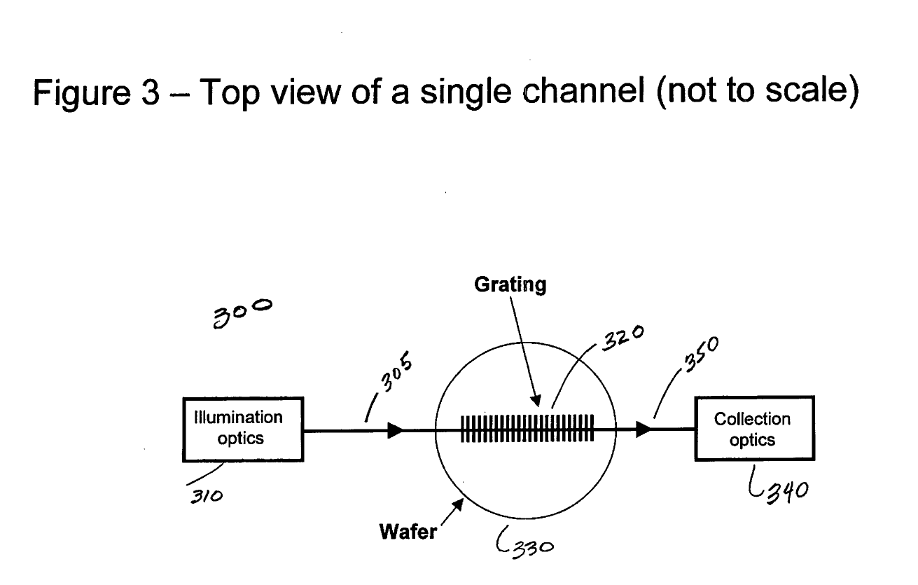

FIG. 3 is a top view of a single channel 300. The illumination optics 310 illuminates with a conditioned radiation 305 a grating 320 on the surface of a wafer 330 and collection optics 340 collects scattered light 350 and converts scattered light to electronic signals. Collection optics communicates with data acquisition and processing electronics, not shown. The three terms grating, array structures, and repetitive array of structures are interchangeable; as is feature and structure.

FIG. 4 shows relevant angles with reference to an illumination beam 305. Angle θₒ 410 is the illumination angle and angle 2α is the spread 420. A reflected wave will have a similar structure; a measurement as a function of illumination angle has a range of angles, 2α; m this embodiment a variable, θ, 430, varies from θₒ−α to θ_{o+α.}

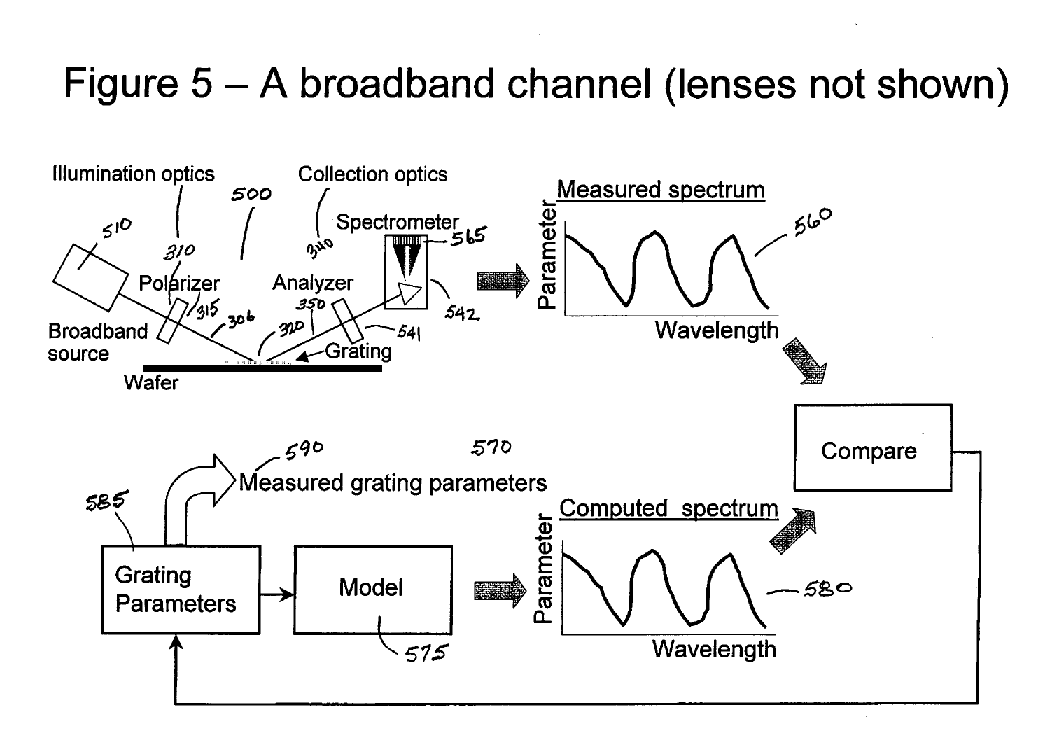

FIG. 5 is one embodiment of a single channel of a broadband system 500. Broadband source provides radiation to illumination optics 310, in this embodiment shown as polarizer 315 only, illuminating a grating 320 with a broadband beam 306; note, not all possible illumination optical elements are shown. Collection optics 340 comprises analyzer 541 and spectrometer 542 decomposing collected radiation 350; note, not all possible collection optical elements are shown. A spectral signal is directed onto a CCD or linear array, indicated by parallel lines 565. Polarizer 315 and analyzer 541 may be stationary to produce reflectometry parameters, for instance, reflectivity at S or P polarization or cross polarization terms, a conversion from S to P or each may rotate to produce ellipsometric parameters. One or more of these parameters are measured as a function of wavelength 560. Processing means 570 with a predetermined algorithm 575 computes a spectral fingerprint 580 based on a priori knowledge of a set of grating parameters 585; algorithm fitting parameters are varied until a best fit is obtained between the measured and computed spectra. After a best fit is obtained, the last set of algorithm fitting parameters used in an algorithm are termed the “measured grating parameters” 590. In this embodiment, an illumination angle, not shown, is preferably fixed; a spectral fingerprint is determined as a function of wavelength. Alternatively a library of pre-computed spectra may be stored in digital form and a measured spectrum maybe compared with pre-computed spectra a best match.

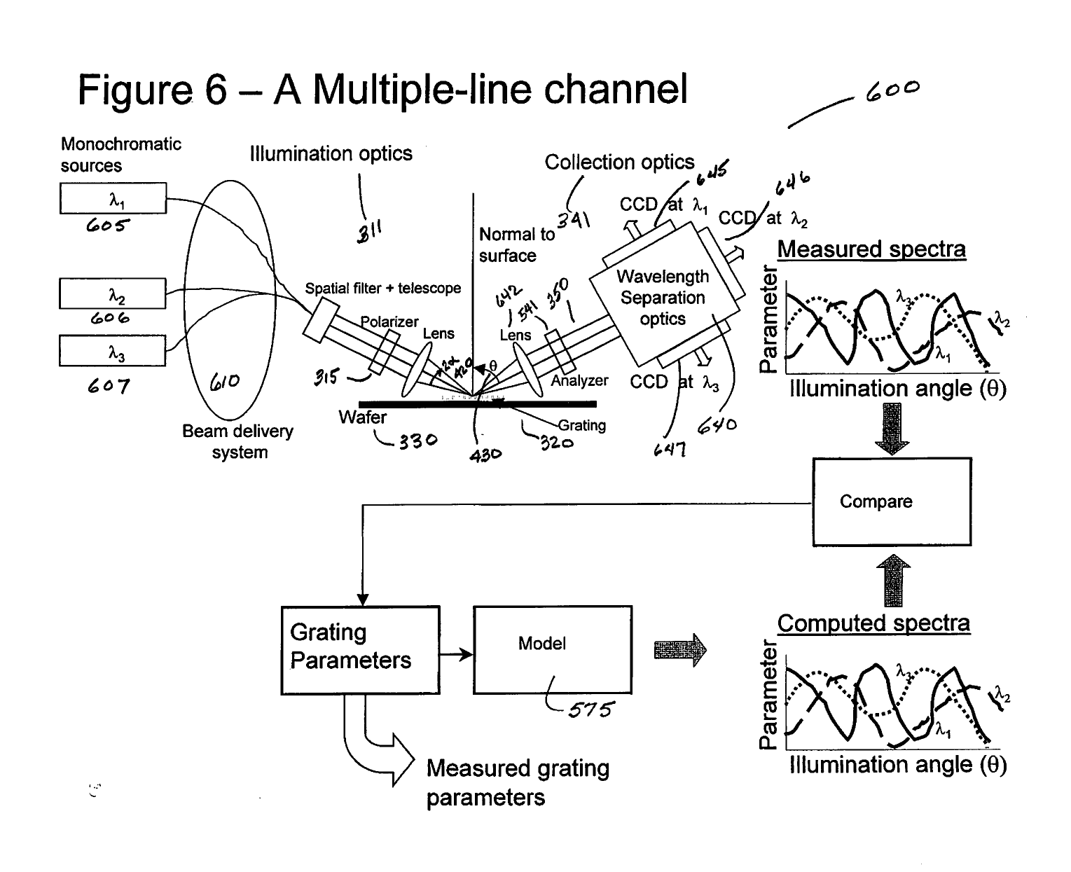

FIG. 6 is a multiple-line wavelength system 600. In this embodiment a wafer 330 is illuminated by illumination optics 311 sourced from beam delivery system 610 comprising several discrete wavelengths 605, 606, 607 over a range of illumination angles, 2α 420. Collection optics 341, comprising lens 642, analyzer 541, collects beam 350, collimates it and transmits through wavelength separation optics 640 to separate CCD's 645, 646, 647, optionally linear arrays, a signal received for each discrete wavelength. Polarizer 315 or analyzer 541 may be stationary to produce reflectometry parameters, for example, reflectivity at S or P polarization or cross polarization terms that is a conversion from S to P or P to S. Alternatively either the polarizer or the analyzer or both or neither may rotate to produce ellipsometric parameters. A model 575 or algorithm is used to process a signal at each wavelength as a function of angle θ 430; three wavelengths λ₁ 605, λ₂ 606, and λ₃ 607 are shown; the instant invention is not limited to three wavelengths. It is important to note that in this case, after a collected beam is collimated, each ray in the beam corresponds to a certain illumination angle 430; as a beam is directed to a CCD or a linear array, each element of this device produces a signal that corresponds to a unique given illumination angle, θ. Again a computed spectra is a function of angle; at each wavelength a computed spectra is compared to corresponding measured data; a set of grating parameters is adjusted until a best fit is achieved. Alternatively a library of pre-computed or historical spectra as a function of both angle and wavelength may be stored digitally and the measured spectrum maybe compared with this library and best match maybe sought. One advantage of this method over a broadband method is that the dispersion of the materials involved need not be known over a broad range of wavelengths.

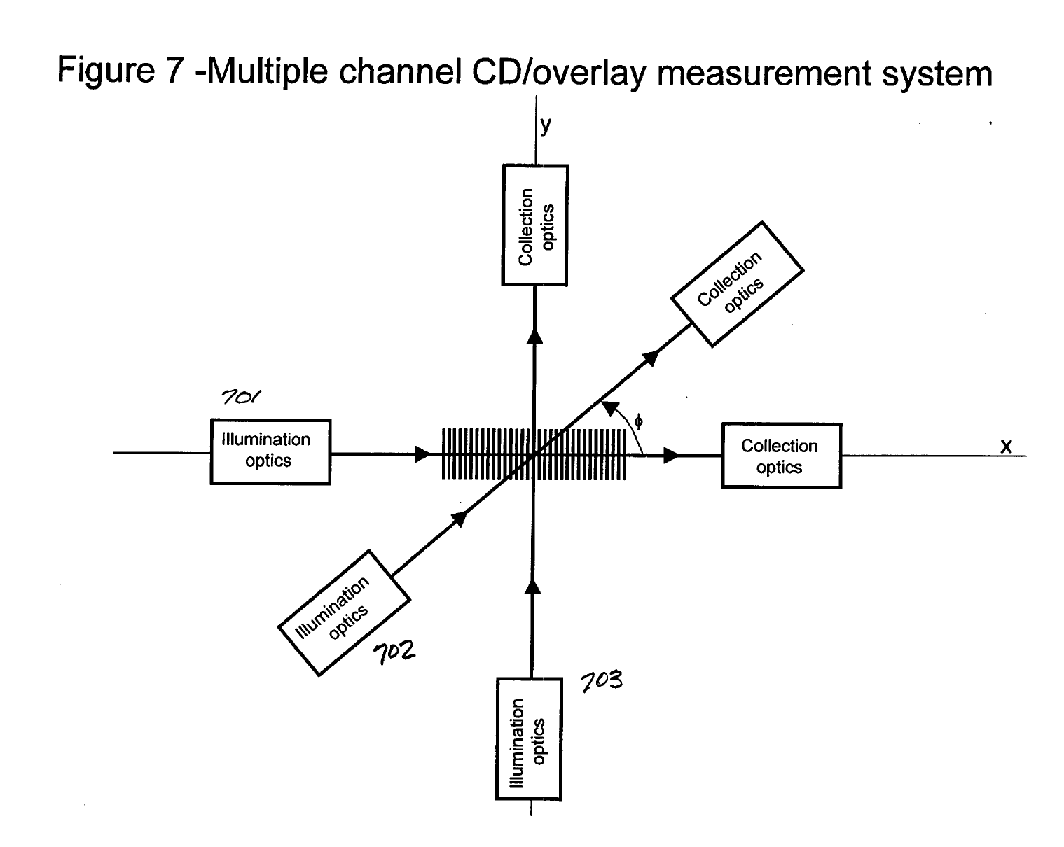

FIG. 7, a wafer is not shown, is one embodiment of an illumination-collection optics pair, described with reference to FIG. 5 or FIG. 6. Note, FIGS. 5 and 6 are exemplary embodiments as is FIG. 7. In FIG. 7 each illumination/collection optics pair is termed a “measurement channel”, as defined previously; each measurement channel may be one of the examples in (a) through (f) or a configuration decided on by one knowledgeable in the field. In this embodiment pairs of illumination-collection optics are azimuthally located around a wafer at predefined azimuthal angles; radiation sources and processing means are not shown. In FIG. 7 channels are at φ=0° 701, φ=45° 702, and φ=90°703. These angles are given only by the way of example and other angles may also be used. Three channels are shown in the figure; this should not be viewed as a limitation; one or more channels may be used. Each channel may have its own radiation source, processing means comprising at least one data acquisition system and processor; one may use parallel or multiplexed processing means to process data obtained from each channel. Alternatively, a channel may share a radiation source, processing means comprising at least one data acquisition system and processor. Furthermore data obtained from a channel may be used by a second channel to accelerate and or/fine tune a computation. Alternatively, one or more radiation sources may provide radiation to one or more illumination optics located at various φᵢᵢ which may be collected by one or more collection optics located at various φ_{ci}; a channel concept does not apply to this group of embodiments. These embodiment are particularly useful for characterization of line edge roughness.

Foregoing described embodiments of the invention are provided as illustrations and descriptions. They are not intended to limit the invention to precise form described. In particular, it is contemplated that functional implementation of invention described herein may be implemented equivalently. Alternative construction techniques and processes are apparent to one knowledgeable with optics, scatterometry, integrated circuit and MEMS technology. Other variations and embodiments are possible in light of above teachings, and it is thus intended that the scope of invention not be limited by this Detailed Description, but rather by Claims following.

What I claim is:

1. An apparatus for measuring a structure on a surface comprising:
one or more radiation sources;
two or more channels wherein each channel comprises;
illumination optics;
collection optics; and
processing means for analyzing and comparing spectral data;
wherein the structure comprises a predetermined array of structures.

2. The apparatus of claim 1 wherein said illumination optics comprises at least one from a group comprising reflective optics, fiber optics, lenses, optical filters, diffraction gratings, polarizers, wave plates, windows, opto-mechanical holders, beam-splitters, dichroic mirrors, optical modulators, telescopes, collimators, spatial light modulators, means for rotating a polarizer continuously or not, and spatial filters.

3. The apparatus of claim 1 wherein said collection optics comprises at least one from a group comprising windows, reflective optics, fiber optics, lenses, optical filters, diffraction gratings, analyzers, wave plates, windows, opto-mechanical holders, telescopes, collimators, spatial filters, beam-splitters, dichroic mirrors, photodetectors, silicon detectors, photomultiplier tubes, CCD's, linear arrays detector arrays, means for rotating an analyzer continuously or not, wavelength separation optics and spatial filters.

4. The apparatus of claim 1 wherein said one or more radiation sources comprises one or more sources chosen from a group comprising xenon arc lamp, mercury lamp, deuterium lamp, gas lasers, solid state lasers, and solid state light emitting device wherein said one or more radiation sources emit simultaneously or sequentially.

5. The apparatus of claim 1 wherein said processing means further comprises a predetermined algorithm, comparing means for spectral signature, at least one set of grating parameters and algorithm fitting parameters.

6. The apparatus of claim 5 wherein said processing means processes spectral data using at least two parameters chosen from a group comprising azimuthal angle, φ, illumination angle, θₒ, wavelengths, λ, polarization state S or P, angular spread, 2α, ellipsometric parameters, ellipsometric ψ or Δ, signal intensity, phase, phase difference, and one or more combinations of phase and amplitude for one or more settings of a polarizer and analyzer.

7. The apparatus of claim 1 wherein said illumination optics illuminates at an angle, θₒ, in a range from about 1 to about 89 degrees.

8. The apparatus of claim 1 wherein said illumination optics illuminates with an angular spread, 2α, in a range from about ±1 to about ±45 degrees about θₒ.

9. The apparatus of claim 1 wherein said one or more radiation sources comprises one or more monochromatic sources.

10. The apparatus of claim 1 wherein said one or more radiation sources comprises one or more polychromatic sources.

11. The apparatus of claim 6 wherein said illumination optics comprises a beam delivery system.

12. The apparatus of claim 11 wherein said beam delivery system further comprises optical fiber.

13. The apparatus of claim 1 wherein said one or more radiation sources comprises at least one wavelength from a group comprising wavelengths of about 980, 830, 670, 633, 532, 488, 405, 364, 248 and 193 nm.

14. An apparatus for measuring a critical dimension of a structure in an array of structures on a surface comprising:
one or more radiation sources emitting one or more wavelengths;
two or more channels wherein each channel comprises:
one or more illuminators;
one or more collectors; and
one or more processing means, wherein the two or more channels are located at predefined azimuthal angles around the surface and focused on about the same area of an array of structures.

15. The apparatus of claim 14 wherein said illumination optics comprises at least one from a group comprising reflective optics, fiber optics, lenses, optical filters, diffraction gratings, polarizers, wave plates, windows, opto-mechanical holders, beam-splitters, dichroic mirrors, optical modulators, telescopes, collimators, spatial light modulators, means for rotating a polarizer continuously or not, and spatial filters.

16. The apparatus of claim 14 wherein said collection optics comprises at least one from a group comprising reflective optics, windows, fiber optics, lenses, optical filters, diffraction gratings, analyzers, wave plates, windows, opto-mechanical holders, telescopes, collimators, spatial filters, beam-splitters, dichroic mirrors, photodetectors, silicon detectors, photomultiplier tubes, CCD's, linear arrays detector arrays, means for rotating an analyzer continuously or not, wavelength separation optics and spatial filters.

17. The apparatus of claim 14 wherein said one or more radiation sources comprises one or more sources chosen from a group comprising xenon arc lamp, mercury lamp, deuterium lamp, gas lasers, solid state lasers, and solid state light emitting device wherein said one or more radiation sources emit simultaneously or sequentially.

18. The apparatus of claim 14 wherein said processing means further comprises a predetermined algorithm, comparing means for spectral signature, at least one set of grating parameters and algorithm fitting parameters.

19. The apparatus of claim 18 wherein said processing means processes spectral data using at least two parameters chosen from a group comprising azimuthal angle, φ, illumination angle, θₒ, wavelengths, λ, polarization state S or P, angular spread, 2α, ellipsometric parameters, ellipsometric ψ or Δ, signal intensity, phase, phase difference, and one or more combinations of phase and amplitude for one or more settings of a polarizer and analyzer.

20. The apparatus of claim 14 wherein said illumination optics illuminates at an angle, θₒ, in a range from about 1 to about 89 degrees.

21. The apparatus of claim 14 wherein said illumination optics illuminates with an angular spread, 2α, in a range from about ±1 to about ±45 degrees about θₒ.

22. The apparatus of claim 14 wherein said processing means further comprises processing means capable of processing signals from two or more channels.

23. The apparatus of claim 14 wherein said predefined azimuthal angles, θ, may be at equal increments from 0 to 90 degrees.

24. The apparatus of claim 14 wherein said two or more channels is five or less.

25. The apparatus of claim 14 wherein said predefined azimuthal angles, φ, comprise one or more angles from a group comprising 0, 15, 30, 45, 60, 75 and 90 degrees.

26. An apparatus for measuring an array of structures on a surface comprising:
one or more radiation sources emitting one or more wavelengths, λ;
one or more illumination optics located at one or more azimuthal angles, φ_{ιι}, illuminating at one or more angles, θₒ and one or more angular spreads, 2α;
one or more collection optics located at one or more azimuthal angles, φ_{ci}, for collecting radiation at one or more angles, θₒ and one or more angular spreads, 2α; and
processing means for analyzing and comparing spectral data;
wherein the array of structures comprises structures in a defined pattern.

27. The apparatus of claim 26 wherein said illumination optics comprises at least one from a group comprising reflective optics, fiber optics, lenses, optical filters, diffraction gratings, polarizers, wave plates, windows, opto-mechanical holders, beam-splitters, dichroic mirrors, optical modulators, telescopes, collimators, spatial light modulators, means for rotating a polarizer continuously or not, and spatial filters.

28. The apparatus of claim 26 wherein said collection optics comprises at least one from a group comprising reflective optics, windows, fiber optics, lenses, optical filters, diffraction gratings, analyzers, wave plates, windows, opto-mechanical holders, telescopes, collimators, spatial filters, beam-splitters, dichroic mirrors, photodetectors, silicon detectors, photomultiplier tubes, CCD's, linear arrays detector arrays, means for rotating an analyzer continuously or not, wavelength separation optics and spatial filters.

29. The apparatus of claim 26 wherein said one or more radiation sources comprise one or more sources chosen from a group comprising xenon arc lamp, mercury lamp, deuterium lamp, gas lasers, solid state lasers, and solid state light emitting device wherein said one or more radiation sources emit simultaneously or sequentially.

30. The apparatus of claim 26 wherein said processing means further comprises a predetermined algorithm, comparing means for spectral signature, at least one set of grating parameters and algorithm fitting parameters.

31. The apparatus of claim 30 wherein said processing means processes spectral data using at least two parameters chosen from a group comprising azimuthal angles, φᵤ and φ_{ci}, illumination angle, θₒ, wavelengths, λ, polarization state S or P, angular spread, 2α, ellipsometric parameters, ellipsometric ψ or Δ, signal intensity, phase, phase difference, and one or more combinations of phase and amplitude for one or more settings of a polarizer and analyzer.

32. The apparatus of claim 26 wherein said illumination optics illuminates at an angle, θₒ, in a range from about 1 to about 89 degrees and said collection optics collects at an angle, θₒ, in a range from about 1 to about 89 degrees.

33. The apparatus of claim 26 wherein said illumination optics illuminates with an angular spread, 2α, in a range from about ±1 to about ±45 degrees about θᵢᵢ.

34. The apparatus of claim 26 wherein said illumination optics azimuthal angle, φ_{ιι}, has a range from 0 to 90 degrees and said collection optics azimuthal angle, φ_{cι}, has a range from 180 to 270 degrees.
